(19) United States
(12) Patent Application Publication
(10) Pub. No.: US 2026/0211599 A1
(43) Pub. Date: Jul. 23, 2026

(54) PRINTING APPARATUS AND CONTROL METHOD THEREFOR FOR PROVIDING RANDOM PRINT SERVICE

(71) Applicant: CANON KABUSHIKI KAISHA, Tokyo (JP)

(72) Inventor: Ryusuke Okuhara, Kanagawa (JP)

(21) Appl. No.: 19/413,082

(22) Filed: Dec. 9, 2025

(30) Foreign Application Priority Data
Jan. 23, 2025 (JP) 2025-009989

(51) Int. Cl. G06F 3/12

(52) U.S. Cl. CPC G06F 3/1254; G06F 3/1204; G06F 3/127

(57) ABSTRACT

A printing apparatus is configured to access a removable or built-in recording medium. The printing apparatus includes a first print mode, a second print mode, and a third print mode. In the first print mode, the printing apparatus prints image data selected by a user from among a plurality of image data items stored in the recording medium. In the second print mode, the printing apparatus prints image data automatically selected based on a predetermined rule from among the plurality of image data items stored in the recording medium. In the third print mode, the operation of the second print mode is managed.

### BACKGROUND

### Field of the Technology

The present disclosure relates to a printing apparatus and a control method for the printing apparatus.

### Description of the Related Art

In recent years, there has been an increasing demand for services that provide printing in which image data to be printed is randomly selected from among a plurality of pieces of image data (hereinafter referred to as “random print”).

For example, Japanese Patent Application Laid-Open No. 2006-313990 discloses a system including a printing apparatus, a server that stores a plurality of pieces of image data, and a personal computer that instructs the server to randomly select image data from among the plurality of pieces of image data and to send the selected image data to the printing apparatus. Since users cannot predict which image data will be printed by this system, the pleasure of obtaining a printed product of the desired image data is enhanced.

However, the above-described conventional system is implemented as a large-scale system including a server, a personal computer, and a printing apparatus, and therefore the locations where the system can be installed are limited.

### SUMMARY

Embodiments described herein are directed to technology that enables a random print service to be provided with a simple and compact configuration.

In one embodiment, a printing apparatus is configured to access a removable or built-in recording medium. The printing apparatus includes a first print mode, a second print mode, and a third print mode. In the first print mode, the printing apparatus prints image data selected by a user from among a plurality of image data items stored in the recording medium. In the second print mode, the printing apparatus prints image data automatically selected based on a predetermined rule from among the plurality of image data items stored in the recording medium. In the third print mode, the operation of the second print mode is managed.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of the internal configuration of a printing apparatus according to an embodiment.

FIGS. 2A and 2B are external views of the printing apparatus illustrated in FIG. 1.

FIG. 3 is a diagram illustrating an example of a folder structure of a recording medium illustrated in FIG. 1.

FIG. 4 is a flowchart illustrating the procedure of a print mode switching process performed by the printing apparatus illustrated in FIG. 1.

FIG. 5 is a diagram illustrating an example of a home screen for a random print mode displayed on a display unit illustrated in FIG. 1.

FIG. 6 is a flowchart illustrating the procedure of a random print control process performed by a conventional printing apparatus.

FIG. 7 is a flowchart illustrating the procedure of a random print control process performed by the printing apparatus illustrated in FIG. 1.

FIGS. 8A to 8G are diagrams for explaining the operation of a normal print mode in the printing apparatus illustrated in FIG. 1.

FIGS. 9A to 9G are diagrams for explaining the operation of a random print administrator mode in the printing apparatus illustrated in FIG. 1.

FIGS. 10A to 10F are diagrams for explaining an example of an operation to change the selection probability of candidate image data for random selection in the random print mode.

FIGS. 11A to 11F are diagrams for explaining an example of an operation to set decorative data in the random print mode.

### DESCRIPTION OF THE EMBODIMENTS

Example embodiments will be described below with reference to the accompanying drawings.

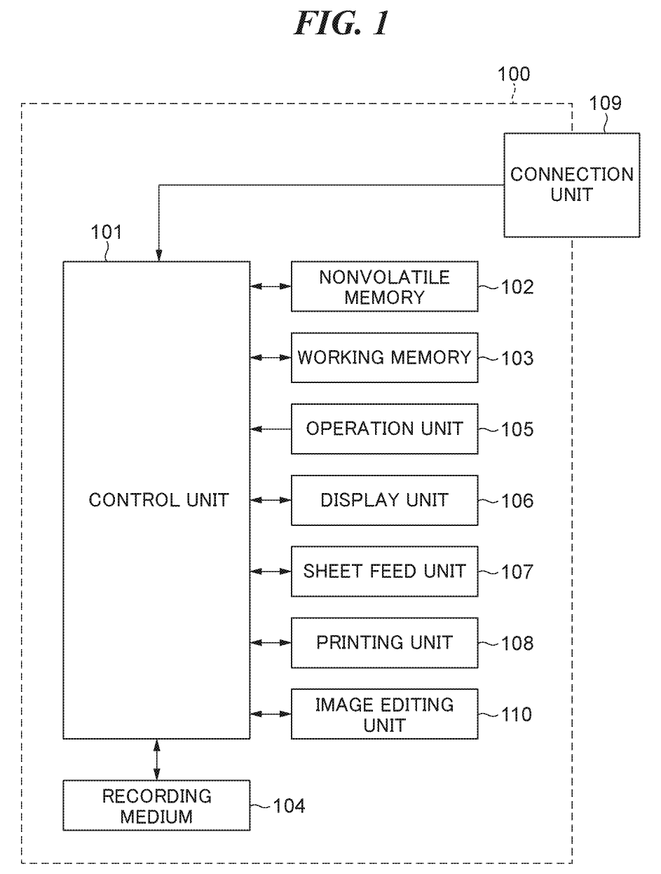

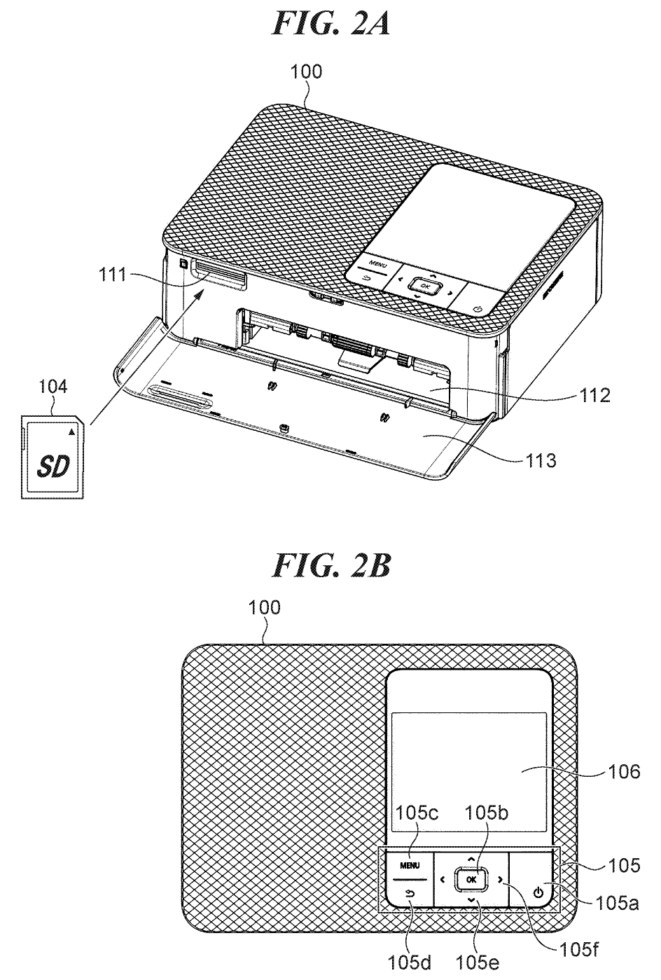

Referring to FIGS. 1, 2A, and 2B, an overview of the configuration and functions of a printing apparatus 100 according to an embodiment will be described.

FIG. 1 is a block diagram illustrating an example of the internal configuration of the printing apparatus 100 according to an embodiment. FIGS. 2A and 2B are external views of the printing apparatus 100 illustrated in FIG. 1: FIG. 2A is an external perspective view of the printing apparatus 100, and FIG. 2B is a top view of the printing apparatus 100.

As illustrated in FIG. 1, the printing apparatus 100 includes a control unit 101, a nonvolatile memory 102, a working memory 103, a recording medium 104, an operation unit 105, a display unit 106, a sheet feed unit 107, a printing unit 108, a connection unit 109, and an image editing unit 110. The control unit 101 is connected to the nonvolatile memory 102, the working memory 103, the recording medium 104, the operation unit 105, the display unit 106, the sheet feed unit 107, the printing unit 108, the connection unit 109, and the image editing unit 110.

The control unit 101 controls various components of the printing apparatus 100 in accordance with input signals or programs (described later). Instead of the control unit 101 controlling the entire printing apparatus 100, a plurality of hardware components may share the processing to control the entire printing apparatus 100.

The nonvolatile memory 102 is an electrically erasable and programmable nonvolatile memory and stores programs (described later) and the like to be executed by the control unit 101.

The working memory 103 is used as a work memory for the control unit 101 to perform processing, as an image display memory for the display unit 106, as a buffer memory for temporarily storing image data received from the connection unit 109, and the like.

The recording medium 104 is capable of storing image data and the like. The recording medium 104 may be configured to be attachable to and detachable from the printing apparatus 100 or may be built into the printing apparatus 100. In other words, the printing apparatus 100 only needs to have at least a function (or capability) for accessing the recording medium 104.

The operation unit 105 is an input device used to receive instructions from a user for the printing apparatus 100. The operation unit 105 includes, for example, operation members such as a power button 105a for turning the power of the printing apparatus 100 on and off, an OK button 105b used for instructing item selection and the like, a MENU button 105c for displaying various menu screens, a return button 105d for canceling various operations, up and down buttons 105e used for changing selected items and the like, and left and right buttons 105f used for scrolling through images during image display or the like.

The display unit 106 displays image data, text, and the like for interactive operation screens. Note that the display unit 106 does not necessarily need to be built into the printing apparatus 100. The printing apparatus 100 may be connected to the display unit 106 provided either internally or externally and only needs to have at least a display control function for controlling display on the display unit 106.

The sheet feed unit 107 accommodates a recording sheet and conveys the recording sheet to the printing unit 108 (described later). The sheet feed unit 107 may be configured to acquire the size of the recording sheet accommodated therein by providing a sensor or a switch for detecting the size of the recording sheet. Alternatively, the sheet feed unit 107 may be configured to accommodate recording sheets of a plurality of sizes. Note that the recording sheet is not limited to paper and may include sheet materials other than paper.

The printing unit 108 performs printing on the recording sheet conveyed from the sheet feed unit 107. The connection unit 109 is an interface for connection to an external device. The printing apparatus 100 of the present embodiment can exchange data with an external device via the connection unit 109.

The image editing unit 110 reads image data stored in the working memory 103 and performs image format conversion (e.g., conversion from a JPEG format to a print data format of the printing apparatus 100). Additionally, the image editing unit 110 combines (or composites) image data with decorative data. The decorative data is data for decorating image data, such as a frame image. In the present embodiment, a JPEG format is given as an example of a file format for image data, and a PNG format is given as an example of a file format for decorative data; however, the formats are not limited thereto.

Next, the external appearance of the printing apparatus 100 will be described. As illustrated in FIG. 2A, a card slot 111 for inserting the recording medium 104 and an attachment opening 112 for a paper feed/discharge tray are provided on the side surface of the printing apparatus 100 and are covered by an open/close cover 113. As illustrated in FIG. 2B, the operation unit 105, including the power button 105a, the OK button 105b, the MENU button 105c, the return button 105d, the up and down buttons 105e, and the left and right buttons 105f, and the display unit 106 are located on the upper surface of the printing apparatus 100.

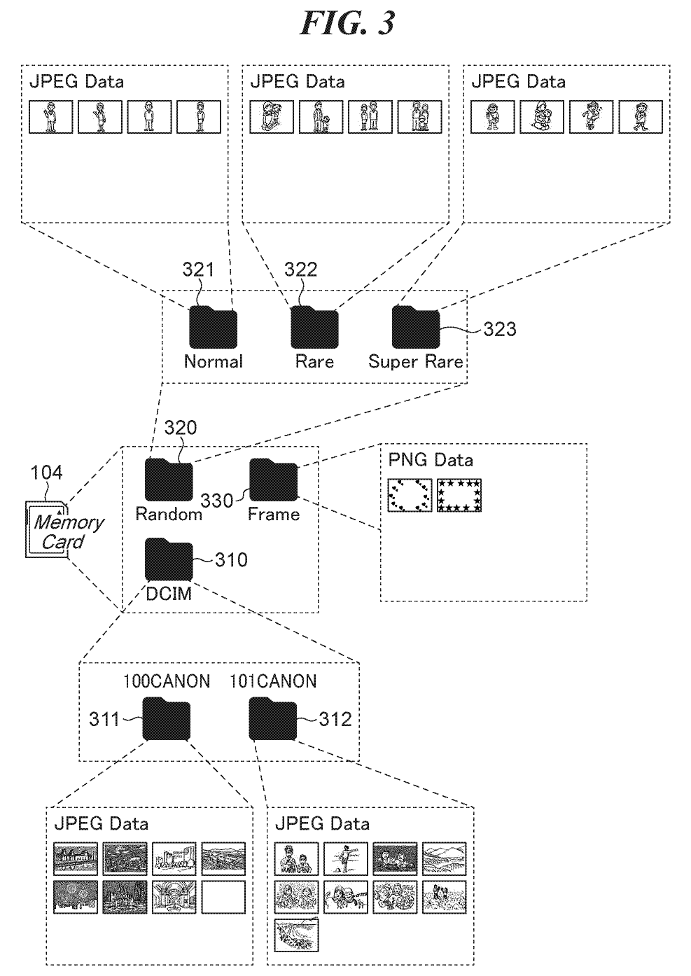

FIG. 3 is a diagram illustrating an example of a folder structure of the recording medium 104 illustrated in FIG. 1. The recording medium 104 includes three folders: a DCIM folder 310, a Random folder 320, and a Frame folder 330, as top-level directories (root directories).

The DCIM folder 310 is a folder defined by the Design rule for Camera File system (DCF) standard, and image data captured by a digital camera or the like is typically stored under this folder. The Random folder 320 is a folder that stores image data used in a random print mode (described later). The Frame folder 330 is a folder that stores decorative data, such as frame images, to be combined with image data in the random print mode (described later).

Next, the random print mode of the printing apparatus 100 will be described. Typically, the printing apparatus 100 displays, on the display unit 106, a plurality of thumbnail images, each corresponding to one of a plurality of image data items stored in the inserted recording medium 104, and prints the image data corresponding to the thumbnail image selected by the user. Hereinafter, such a print mode is referred to as a “normal print mode” (first print mode). In the normal print mode, all image data in a predetermined format, such as JPEG, are candidates for printing, regardless of which folder in the recording medium 104 they are stored in.

The printing apparatus 100 of the present embodiment may also print image data automatically selected based on a predetermined rule from among a plurality of image data items stored in the recording medium 104, without displaying, on the display unit 106, a plurality of thumbnail images each corresponding to one of the image data items. Hereinafter, such a print mode is referred to as a “random print mode” (second print mode).

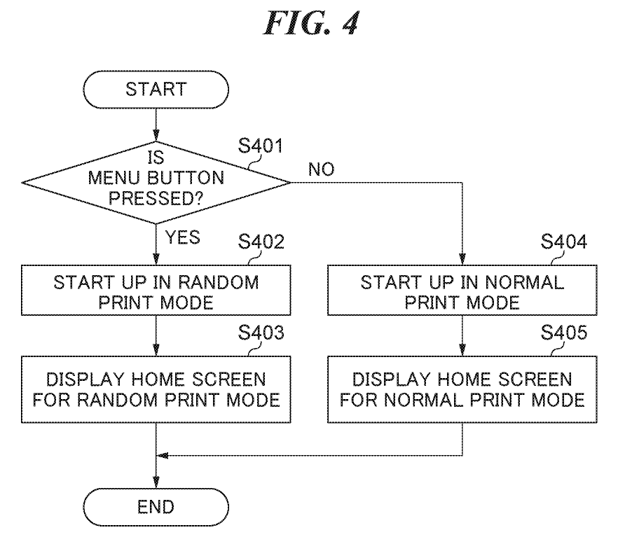

FIG. 4 is a flowchart illustrating the procedure of a print mode switching process performed by the printing apparatus 100 illustrated in FIG. 1. The print mode switching process of FIG. 4 is implemented when the control unit 101 executes a program stored in the nonvolatile memory 102 or the like. The print mode switching process of FIG. 4 starts when the user presses the power button 105a while the printing apparatus 100 is in the power-off state.

In FIG. 4, first, in step S401, the control unit 101 determines whether the user has pressed the MENU button 105c.

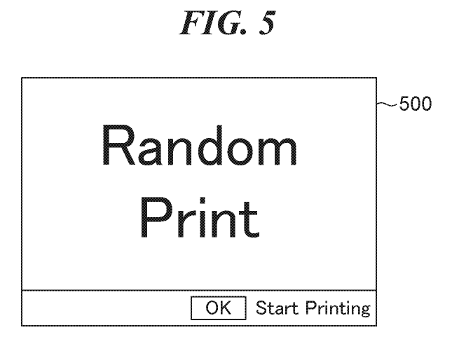

If it is determined in step S401 that the user has pressed the MENU button 105c, the process proceeds to step S402. In step S402, the control unit 101 starts up the printing apparatus 100 in the random print mode. Subsequently, in step S403, the control unit 101 causes the display unit 106 to display a home screen 500 for the random print mode illustrated in FIG. 5. Thereafter, the process ends.

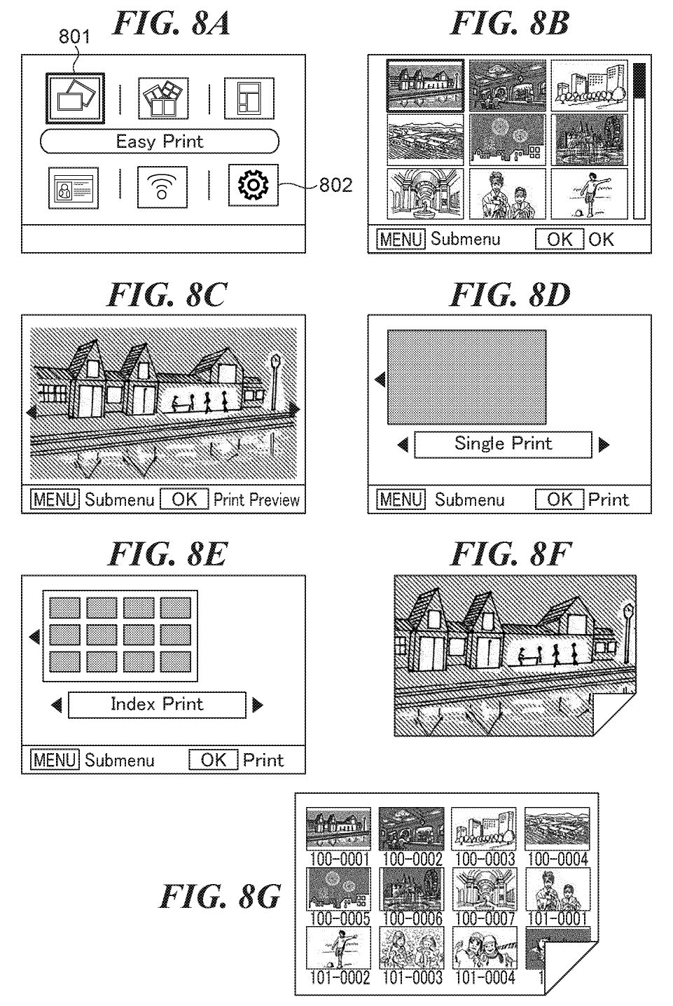

If it is determined in step S401 that the user has not pressed the MENU button 105c, the process proceeds to step S404. In step S404, the control unit 101 starts up the printing apparatus 100 in the normal print mode. Subsequently, in step S405, the control unit 101 causes the display unit 106 to display a home screen for the normal print mode illustrated in FIG. 8A. Thereafter, the process ends.

As described above, the printing apparatus 100 of the present embodiment starts up in the random print mode when the user presses the MENU button 105c together with the power button 105a upon turning on the printing apparatus 100. On the other hand, the printing apparatus 100 of the present embodiment starts up in the normal print mode when the user presses only the power button 105a.

Next, the operation of the random print mode performed by a conventional printing apparatus will be described. In the following description, the conventional printing apparatus is referred to as “conventional printing apparatus 100′.” The conventional printing apparatus 100′ has the same configuration as the printing apparatus 100 illustrated in FIG. 1, and the constituent elements of the conventional printing apparatus 100′ are denoted by the same reference numerals as in FIG. 1, with a prime (′) added to each numeral.

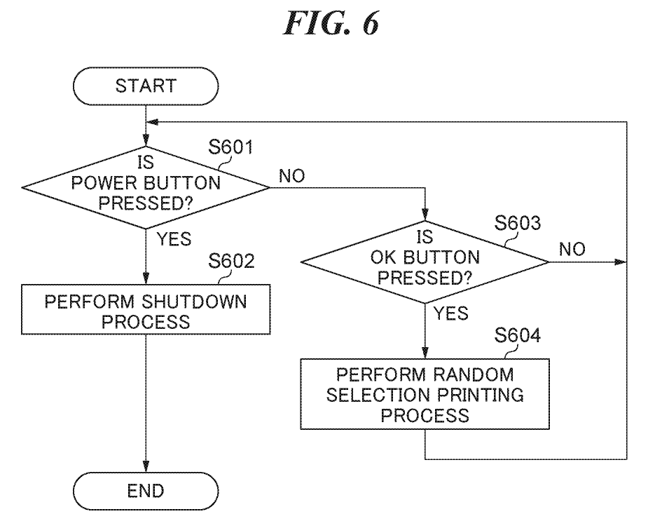

FIG. 6 is a flowchart illustrating the procedure of a random print control process performed by the conventional printing apparatus 100′. The random print control process of FIG. 6 is implemented when a control unit 101′ of the conventional printing apparatus 100′ executes a program stored in a nonvolatile memory 102′ or the like. The random print control process of FIG. 6 starts when the conventional printing apparatus 100′ is started up in the random print mode through the above-described print mode switching process and the home screen 500 for the random print mode is displayed on its display unit 106′.

In FIG. 6, first, in step S601, the control unit 101′ determines whether the user has pressed a power button 105a′.

If it is determined in step S601 that the user has pressed the power button 105a′, the process proceeds to step S602. In step S602, the control unit 101′ performs a shutdown process of the conventional printing apparatus 100′. Thereafter, the process ends.

If it is determined in step S601 that the user has not pressed the power button 105a′, the process proceeds to step S603. In step S603, the control unit 101′ determines whether the user has pressed an OK button 105b′.

If it is determined in step S603 that the user has pressed the OK button 105b′, the process proceeds to step S604. In step S604, the control unit 101′ performs a random selection printing process. In the random selection printing process, one image data item is selected according to a predetermined rule from among candidate image data items for random selection in the random print mode stored in a recording medium 104′. Note that, in the present embodiment, the image data serving as candidates for random selection in the random print mode are those stored in the Random folder 320 and its subfolders (in the hierarchy under the Random folder 320). In the random selection printing process, print data for printing the selected image data is generated by an image editing unit 110′, and a printing unit 108′ performs printing based on the print data. Note that, in the present embodiment, in step S604, the selected image data may be combined with decorative data stored in the Frame folder 330, and printing may be performed based on the resulting composite image data. Thereafter, the process ends.

By using the conventional printing apparatus 100′ as described above, it is possible to provide a service that prints image data automatically selected based on a predetermined rule from among a plurality of pieces of image data stored in the recording medium 104′. However, when providing such a service to end users, the service administrator needs to configure and modify settings related to the image data serving as candidates for random selection in the random print mode, as well as the decorative data.

To address this issue, the printing apparatus 100 of the present embodiment includes, in addition to the normal print mode and random print mode described above, a random print administrator mode (third print mode) to manage the random print mode.

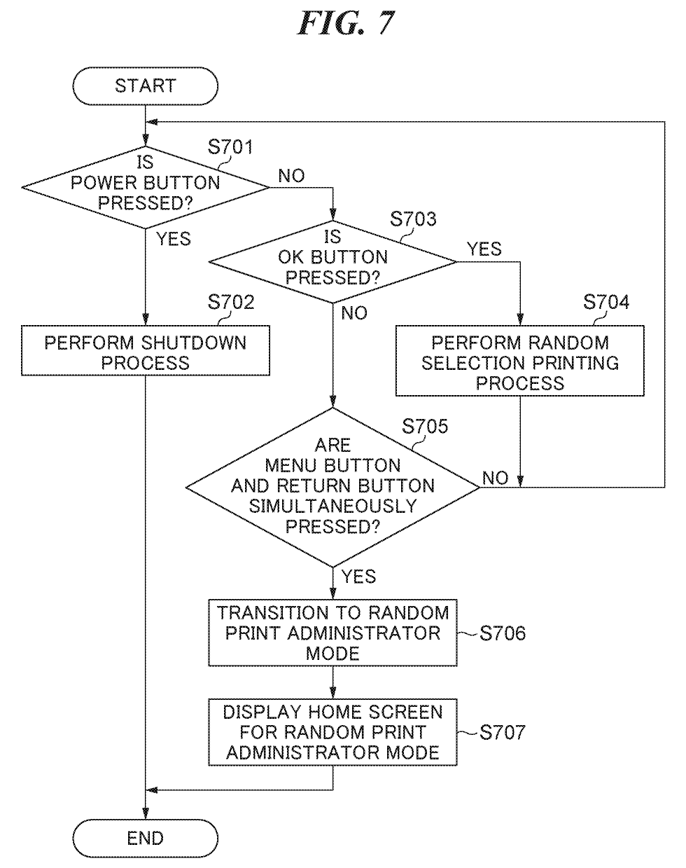

FIG. 7 is a flowchart illustrating the procedure of a random print control process performed by the printing apparatus 100 illustrated in FIG. 1. The random print control process of FIG. 7 is a process similar to the random print control process illustrated in FIG. 6 described above, and the following description focuses on the aspects that differ from the process of FIG. 6. The random print control process of FIG. 7 is implemented when the control unit 101 executes a program stored in the nonvolatile memory 102 or the like. The random print control process of FIG. 7 starts when the printing apparatus 100 is started up in the random print mode through the above-described print mode switching process and the home screen 500 for the random print mode is displayed on the display unit 106.

In FIG. 7, first, steps S701 to S703, which are similar to steps S601 to S603 described above, are performed.

If it is determined in step S703 that the user has pressed the OK button 105b, the process proceeds to step S704, which is similar to step S604 described above. Thereafter, the process returns to step S701.

If it is determined in step S703 that the user has not pressed the OK button 105b, the process proceeds to step S705.

In step S705, the control unit 101 determines whether the user has simultaneously pressed the MENU button 105c (first button) and the return button 105d (second button). If it is determined that the user has not simultaneously pressed the MENU button 105c and the return button 105d, the process returns to step S701. If it is determined that the user has simultaneously pressed the MENU button 105c and the return button 105d, the process proceeds to step S706.

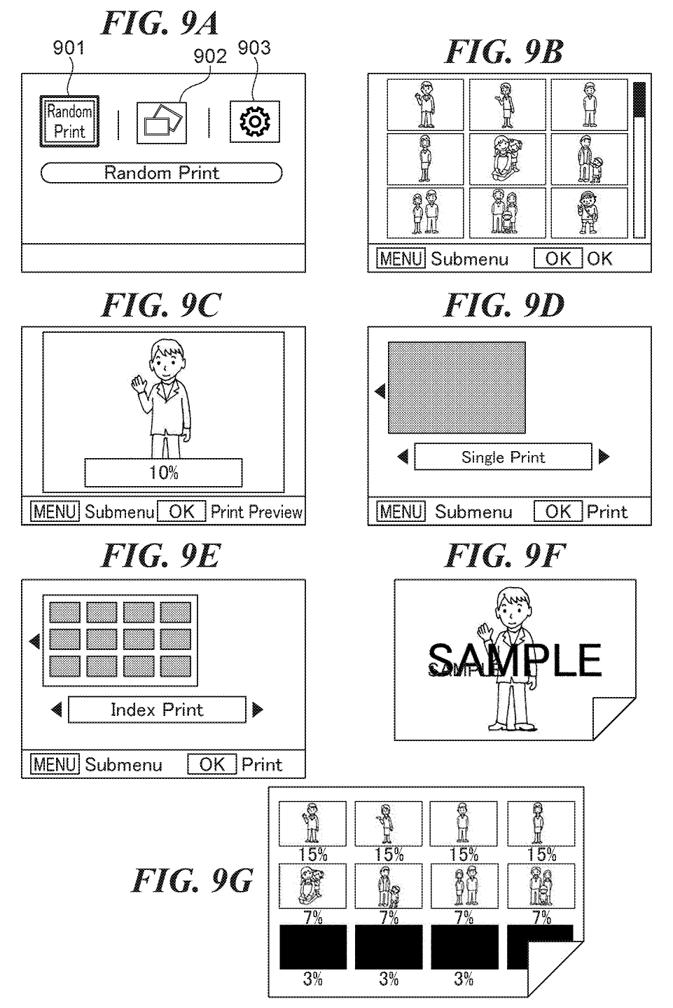

In step S706, the control unit 101 causes the printing apparatus 100 to transition to the random print administrator mode. Subsequently, in step S707, the control unit 101 causes the display unit 106 to display a home screen for the random print administrator mode illustrated in FIG. 9A. Thereafter, the process ends.

As described above, the printing apparatus 100 of the present embodiment transitions to the random print administrator mode when the user simultaneously presses the MENU button 105c and the return button 105d during the random print mode.

Next, the operation of the random print administrator mode in the present embodiment will be described in comparison with the operation of the normal print mode.

FIG. 8A illustrates the home screen for the normal print mode displayed on the display unit 106 when the printing apparatus 100 is started up in the normal print mode. This home screen includes, for example, an easy print icon 801 and a settings change icon 802. The easy print icon 801 is an icon for displaying a screen that allows the user to select image data to be printed from among a plurality of image data items stored in the recording medium 104. When the easy print icon 801 is pressed, the screen displayed on the display unit 106 is switched to a multi-display screen (selection screen) illustrated in FIG. 8B. The settings change icon 802 is an icon for changing various settings of the normal print mode. When any icon is selected using the up and down buttons 105e or the left and right buttons 105f and the OK button 105b is pressed, the printing apparatus 100 performs the function corresponding to the selected icon.

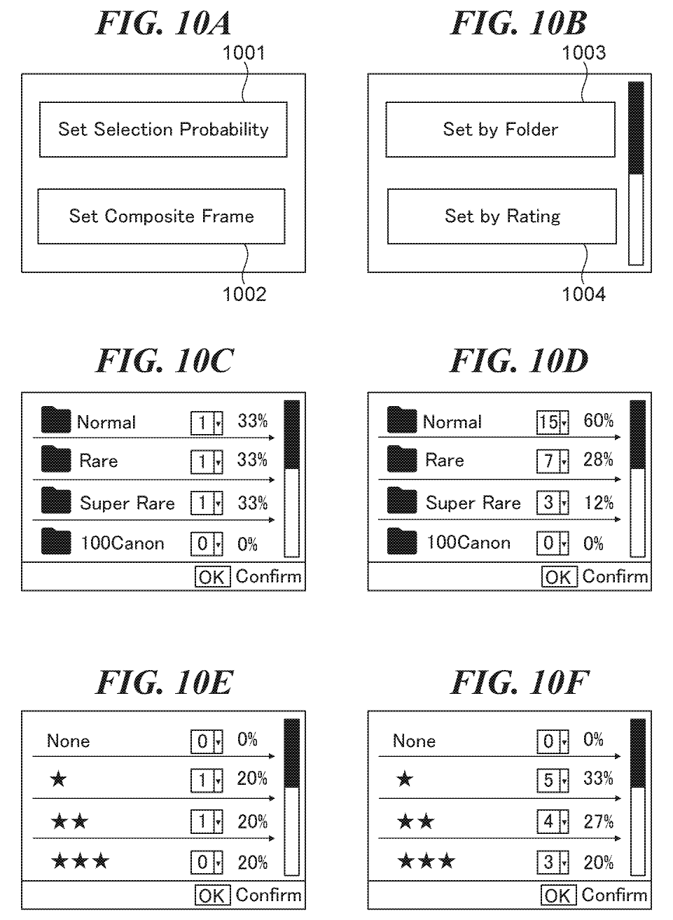

FIG. 9A illustrates the home screen for the random print administrator mode displayed on the display unit 106 when the printing apparatus 100 transitions to the random print administrator mode. This home screen includes, for example, an icon 901, a print confirmation icon 902, and a settings change icon 903. The icon 901 is an icon for transitioning the printing apparatus 100 to the random print mode. The print confirmation icon 902 is an icon for checking image data items serving as candidates for random selection in the random print mode stored in the recording medium 104 and their respective selection probabilities. When the OK button 105b is pressed while the print confirmation icon 902 is selected, the screen displayed on the display unit 106 is switched to a multi-display screen (selection screen) illustrated in FIG. 9B. The settings change icon 903 is an icon for changing various settings of the random print administrator mode. When the OK button 105b is pressed while the settings change icon 903 is selected, the screen displayed on the display unit 106 is switched to a settings change screen illustrated in FIG. 10A. As in the normal print mode, when any icon is selected using the up and down buttons 105e or the left and right buttons 105f of the operation unit 105 and the OK button 105b is pressed, the printing apparatus 100 performs the function corresponding to the selected icon.

Next, the differences between the image display screens in the normal print mode and the random print administrator mode will be described.

In the present embodiment, the image display screens include a multi-display screen, which displays on a single screen a plurality of thumbnail images corresponding to a plurality of image data items that are candidates for printing, and a single-display screen, which displays on a single screen one thumbnail image corresponding to one of the candidate image data items. On the multi-display screen, the user can scroll the screen using the up and down buttons 105e to quickly locate the desired image data. In contrast, the single-display screen is displayed when one thumbnail image is selected on the multi-display screen and the OK button 105b is pressed, and allows the user to view the image data one by one using the left and right buttons 105f. On either image display screen, in the normal print mode, all JPEG-format image data items stored in the recording medium 104 are treated as images to be displayed. On the other hand, in the random print administrator mode, among the JPEG-format image data items stored in the recording medium 104, only the image data items that serve as candidates for random selection in the random print mode are treated as images to be displayed.

In the present embodiment, in the initial state, image data stored in the Random folder 320 and its subfolders (in the hierarchy under the Random folder 320) are treated as candidate image data for random selection in the random print mode. In the random print administrator mode, however, the service administrator can set which image data stored in the recording medium 104 are to be treated as candidate image data for random selection in the random print mode. Details of this setting method will be described later. In the random print administrator mode, the single-display screen illustrated in FIG. 9C displays, together with each thumbnail image, the selection probability of the image data corresponding to the thumbnail image.

In both the normal print mode and the random print administrator mode, when the OK button 105b is pressed on the single-display screen, a print confirmation screen is displayed on the display unit 106. For example, when the OK button 105b is pressed on the single-display screen for the normal print mode illustrated in FIG. 8C, the print confirmation screen illustrated in FIG. 8D or FIG. 8E is displayed on the display unit 106. Similarly, when the OK button 105b is pressed on the single-display screen for the random print administrator mode illustrated in FIG. 9C, the print confirmation screen illustrated in FIG. 9D or FIG. 9E is displayed on the display unit 106. On these print confirmation screens, the user can select either single printing (first printing process) or index printing (second printing process) using the left and right buttons 105f. In single printing, one image data item is printed on a single sheet. In index printing, a plurality of thumbnail images corresponding to a plurality of image data items are printed on a single sheet. The user then instructs the printing apparatus 100 to perform printing by pressing the OK button 105b. FIG. 8F illustrates an example of a printed product output through single printing in the normal print mode, and FIG. 8G illustrates an example of a printed product output through index printing in the normal print mode. FIG. 9F illustrates an example of a printed product output through single printing in the random print administrator mode, and FIG. 9G illustrates an example of a printed product output through index printing in the random print administrator mode.

As illustrated in FIG. 9F, the printed product output through single printing in the random print administrator mode includes information indicating that it is a sample. The information may be, for example, a character string such as “SAMPLE,” as illustrated in FIG. 9F, or a symbol or the like indicating that the printed product is a sample. The output of such a printed product makes it clear that the printed product is a sample. Thus, even if the printed product is displayed at an actual event, the risk of theft or the like can be reduced.

In the present embodiment, a configuration has been described in which information indicating that the printed product is a sample is printed visibly; however, the embodiment is not limited to this configuration. For example, the information indicating that the printed product is a sample may alternatively be printed invisibly (in a latent manner). In a case where the printing apparatus 100 employs a sublimation thermal transfer system that prints by vaporizing ink with heat, the printing apparatus 100 performs a special film treatment (overcoat finishing) at the final stage of the printing process. In this film treatment, processing may be applied to the overcoat layer (protective layer) such that the information indicating that the printed product is a sample is printed in a latent manner. As a result, a printed product is output in which the information indicating that it is a sample is invisible when viewed from the front but visible when viewed from an oblique angle.

In a printed product output through index printing in the random print administrator mode, the selection probabilities of image data items serving as candidates for random selection in the random print mode may be included in association with the respective image data items. This allows the service administrator, as the user, to quickly check, in a list format, the selection probabilities of the candidate image data items for random selection in the random print mode. In addition, at an actual event, the service administrator can present the candidate image data items for random selection in the random print mode to the service users. In the random print administrator mode, it may be possible to control whether to include the selection probabilities in the printed product output through index printing in the random print administrator mode, in accordance with an instruction from the service administrator as the user. For example, the service administrator may set, on a setting screen (not illustrated), whether to include the selection probabilities, and the above control may be performed based on this setting. This allows the output, through index printing, of a printed product that either includes or does not include the selection probabilities, depending on the purpose of the service administrator.

In addition, in a printed product output through index printing in the random print administrator mode, for example, a black image may be printed in place of the thumbnail image of an image data item with a selection probability lower than a threshold, such as a “super rare” image. This allows the service user to recognize the presence of super rare image data items, such as secret images, when the printed product is presented. In the random print administrator mode, it may be possible to control whether to print a black image in place of the thumbnail image of an image data item with a selection probability lower than the threshold in index printing, in accordance with an instruction from the service administrator as the user. For example, the service administrator may set, on a setting screen (not illustrated), whether to print a black image, and the above control may be performed based on this setting. This allows the output, through index printing, of either a printed product in which only the super rare image data items are replaced with black images or a printed product in which all candidate image data items for random selection in the random print mode are printed without being replaced with black images, depending on the purpose of the service administrator.

Next, a description will be given of how to change the settings of the random print mode performed in the random print administrator mode.

FIGS. 10A to 10F are diagrams for explaining an example of an operation to change the selection probability of candidate image data for random selection in the random print mode. As described above, when the OK button 105b is pressed while the settings change icon 903 is selected on the home screen for the random print administrator mode illustrated in FIG. 9A, the screen displayed on the display unit 106 is switched to the settings change screen illustrated in FIG. 10A.

When the OK button 105b is pressed while a “Set Selection Probability” button 1001 is selected on the settings change screen illustrated in FIG. 10A, the screen displayed on the display unit 106 is switched to the screen illustrated in FIG. 10B.

When the OK button 105b is pressed while a “Set by Folder” button 1003 is selected on the screen illustrated in FIG. 10B, the screen displayed on the display unit 106 is switched to the screen illustrated in FIG. 10C. FIG. 10C illustrates, as an example, a state in which the selection probabilities of the folders in the lower hierarchy under the Random folder 320 are all set to the same value. As illustrated in FIG. 3, the Random folder 320 contains three folders: a “Normal” folder 321, a “Rare” folder 322, and a “Super Rare” folder 323. Accordingly, the selection probabilities of these folders are each 33.33...%. Since each of these folders stores four image data items, as illustrated in FIG. 3, the selection probability of each image data item is 8.33...%. From this state, if the settings are changed as illustrated in FIG. 10D such that the selection probability of the “Normal” folder 321 is set to 60%, that of the “Rare” folder 322 is set to 28%, and that of the “Super Rare” folder 323 is set to 12%, the selection probabilities of the individual image data items become as follows: the selection probability of each image data item stored in the “Normal” folder 321 is 15%, that of each image data item stored in the “Rare” folder 322 is 7%, and that of each image data item stored in the “Super Rare” folder 323 is 3%.

In this manner, by setting the selection probability for each folder, it is possible, in a configuration in which image data are managed in folders classified by rarity level, to easily set the selection probabilities according to the rarity level.

In the present embodiment, image data stored in a folder with a selection probability set to 0% on the screen illustrated in FIG. 10C are not treated as candidate image data for random selection in the random print mode. In other words, the service administrator can exclude image data stored in a particular folder from the candidate image data for random selection in the random print mode by changing the settings on the screen illustrated in FIG. 10C to set the selection probability of that folder to 0%.

In addition, in the present embodiment, the selection probability can be set based on rating information included in Exif information attached to the candidate image data for random selection in the random print mode. The rating information indicates the rarity level of the image data. For example, when the OK button 105b is pressed while a “Set by Rating” button 1004 is selected on the screen illustrated in FIG. 10B, the screen displayed on the display unit 106 is switched to the screen illustrated in FIG. 10E. FIG. 10E illustrates, as an example, a state in which the selection probabilities from one star (★ in FIG. 10E), representing the lowest rarity level, to five stars (not illustrated), representing the highest rarity level, are all set to the same value. From this state, the settings can be changed as illustrated in FIG. 10F to set a different selection probability for each image data.

In this manner, by setting the selection probability based on each piece of rating information, it is possible to easily set the selection probability according to the rarity level corresponding to the rating information.

Image data stored in a folder with a selection probability set to 0% on the screen illustrated in FIG. 10E are also not treated as candidate image data for random selection in the random print mode. In other words, the service administrator can exclude image data stored in a particular folder from the candidate image data for random selection in the random print mode by changing the settings on the screen illustrated in FIG. 10E to set the selection probability of that folder to 0%.

In the present embodiment, it is also possible to set the selection probability for each image data item individually. In this manner, by setting the selection probability for each image data item, detailed settings with different selection probabilities for respective image data items can be configured.

By adopting a configuration that allows the selection probability in the random print mode to be changed in this manner, it is possible to enhance the entertainment aspect of the random print mode.

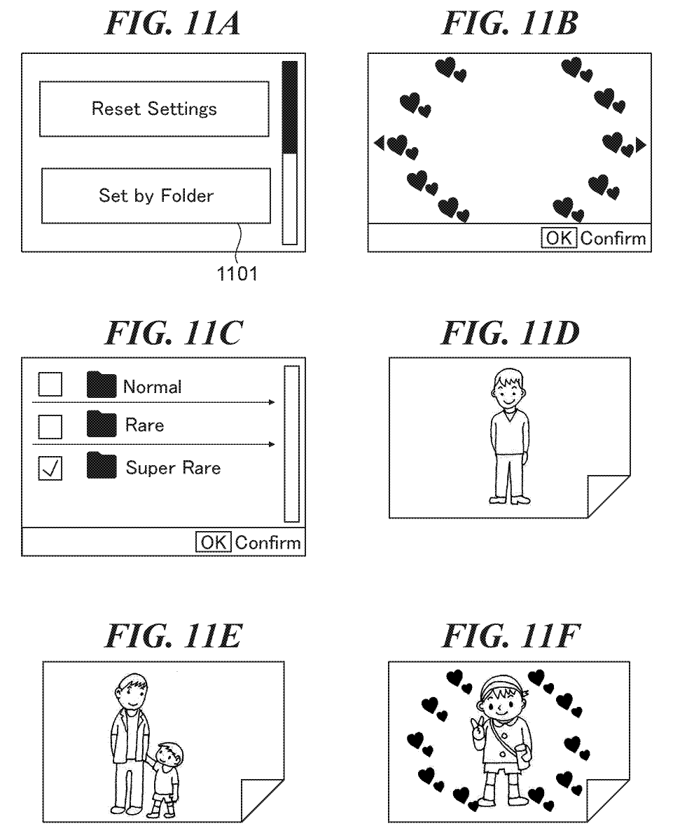

FIGS. 11A to 11F are diagrams for explaining an example of an operation to set decorative data in the random print mode.

When the OK button 105b is pressed while a “Set Composite Frame” button 1002 is selected on the settings change screen illustrated in FIG. 10A, the screen displayed on the display unit 106 is switched to the screen illustrated in FIG. 11A. When the OK button 105b is pressed while a “Set by Folder” button 1101 is selected on the screen illustrated in FIG. 11A, the screen displayed on the display unit 106 is switched to the screen illustrated in FIG. 11B. On the screen illustrated in FIG. 11B, PNG data stored in the Frame folder 330 are displayed, and decorative data can be selected using the left and right buttons 105f. When the OK button 105b is pressed while the screen illustrated in FIG. 11B is displayed, the screen displayed on the display unit 106 is switched to the screen illustrated in FIG. 11C. On this screen, folders each storing candidate image data for random selection in the random print mode are displayed in a list, and one of the folders can be selected to specify that, when image data stored therein is selected in the random selection, the decorative data selected on the screen illustrated in FIG. 11B will be combined with the image data. FIGS. 11D, 11E, and 11F each illustrate an example of a printed product output in the random print mode when the “Super Rare” folder is specified as the folder whose image data is to be combined with the decorative data.

FIG. 11D illustrates an example in which image data stored in the “Normal” folder 321 is selected and printed. FIG. 11E illustrates an example in which image data stored in the “Rare” folder 322 is selected and printed. FIG. 11F illustrates an example in which image data stored in the “Super Rare” folder 323 is selected and printed. When image data stored in a folder not specified on the screen illustrated in FIG. 11C is selected, the printing apparatus 100 prints the image data as is, for example, as illustrated in FIG. 11D or FIG. 11E. On the other hand, when image data stored in a folder specified on the screen illustrated in FIG. 11C is selected, the printing apparatus 100 prints composite data obtained by combining the image data with the decorative data, for example, as illustrated in FIG. 11F. In the present embodiment, the decorative data may also be printed on the overcoat layer. This makes it possible to provide the service user with a printed product of image data including decorative data that may appear differently depending on the viewing angle.

In the present embodiment, a configuration has been described in which decorative data is set with respect to a folder; however, the embodiment is not limited to this configuration, and decorative data may be set for each individual image.

According to the embodiment described above, the printing apparatus 100 has a normal print mode, a random print mode, and a random print administrator mode for managing the random print mode. In other words, a random print service that includes both printing in the random print mode, in which image data is automatically selected based on a predetermined rule from among a plurality of image data items stored in the recording medium 104, and management of the random print mode is realized solely by the printing apparatus 100. This makes it possible to provide the random print service with a simple and compact configuration.

Additionally, in the embodiment described above, in the normal print mode, all JPEG-format image data items stored in the recording medium 104 are displayed on the display unit 106 as print candidates. On the other hand, in the random print administrator mode, only the image data items serving as candidates for random selection in the random print mode, among the JPEG-format image data items stored in the recording medium 104, are displayed on the display unit 106 as print candidates. This allows the service administrator to easily check only the candidate image data items for random selection in the random print mode while in the random print administrator mode.

Furthermore, in the embodiment described above, on the multi-display screen illustrated in FIG. 9B, the selection probability in the random print mode is displayed in association with each thumbnail image. Specifically, the selection probability of the image data corresponding to each thumbnail image is displayed together with the thumbnail image. Accordingly, the service administrator can easily check, on the multi-display screen, a list of image data items serving as candidates for random selection in the random print mode, together with their respective selection probabilities.

According to the embodiment described above, a random print service can be provided with a simple and compact configuration.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-009989, filed January 23, 2025, which is hereby incorporated by reference herein in its entirety.

What is claimed is:

1. A printing apparatus configured to access a recording medium, the printing apparatus comprising:
a first print mode configured to print image data selected by a user from among a plurality of image data items stored in the recording medium;
a second print mode configured to print image data automatically selected based on a predetermined rule from among the plurality of image data items stored in the recording medium; and
a third print mode configured to manage the second print mode.

2. The printing apparatus according to claim 1, wherein
in the first print mode, all image data in a predetermined format stored in the recording medium are displayed as print candidates on a display connected to the printing apparatus, and
in the third print mode, among the image data in the predetermined format stored in the recording medium, only image data that are candidates for printing in the second print mode are displayed as print candidates on the display connected to the printing apparatus.

3. The printing apparatus according to claim 2, wherein, in the third print mode, the image data that are displayed as the print candidates on the display are each displayed in association with a selection probability of the image data in the second print mode.

4. The printing apparatus according to claim 1, wherein, in the third print mode, a print process specified by the user is performed, the print process being a first print process that prints one image data item on a single sheet, or a second print process that prints a plurality of thumbnail images, each corresponding to one of a plurality of image data items, on a single sheet.

5. The printing apparatus according to claim 4, wherein, in the first print process in the third print mode, a printed product of the one image data item is output, the one image data item being selected by the user from among image data items that are candidates for printing in the second print mode and stored in the recording medium, and information indicating that the printed product is a sample is printed in a visible manner on the printed product.

6. The printing apparatus according to claim 4, wherein, in the first print process in the third print mode, a printed product of the one image data item is output, the one image data item being selected by the user from among image data items that are candidates for printing in the second print mode and stored in the recording medium, and processing is applied to a protective layer of the printed product such that information indicating that the printed product is a sample is printed in a latent manner.

7. The printing apparatus according to claim 4, wherein, in the second print process in the third print mode, a single printed product including the plurality of thumbnail images corresponding to the plurality of image data items is output, the plurality of image data items being candidates for printing in the second print mode and stored in the recording medium, and selection probabilities of the image data items corresponding to the respective thumbnail images in the second print mode are printed on the printed product in association with the respective thumbnail images.

8. The printing apparatus according to claim 7, further comprising a controller configured to control, in accordance with an instruction from the user, whether to include the selection probabilities in the printed product output in the second print process in the third print mode.

9. The printing apparatus according to claim 7, wherein, in the printed product, a black image is printed in place of a thumbnail image corresponding to image data with a selection probability lower than a threshold.

10. The printing apparatus according to claim 9, further comprising a controller configured to control, in accordance with an instruction from the user, whether to print the black image in place of the thumbnail image in the printed product output in the second print process in the third print mode.

11. The printing apparatus according to claim 1, further comprising a controller configured to change, in accordance with an instruction from the user, a selection probability of image data that is a candidate for printing in the second print mode.

12. The printing apparatus according to claim 11, wherein the controller is configured to change the selection probability for each folder in the recording medium.

13. The printing apparatus according to claim 11, wherein the controller is configured to change the selection probability for each piece of rating information indicating a rarity level of image data that is a candidate for printing in the second print mode.

14. The printing apparatus according to claim 13,
wherein the image data that is a candidate for printing in the second print mode includes Exif information containing the rating information indicating the rarity level of the image data.

15. The printing apparatus according to claim 11, wherein the controller is configured to change the selection probability for each image data that is a candidate for printing in the second print mode.

16. The printing apparatus according to claim 1, wherein, in the third print mode, decorative data is set to be printed together with predetermined image data when the predetermined image data is selected in the second print mode.

17. The printing apparatus according to claim 16, wherein
when the predetermined image data is selected in the second print mode, a printed product of composite data is output, and
the composite data is obtained by combining the predetermined image data with the decorative data set in the third print mode.

18. The printing apparatus according to claim 16, wherein
when the predetermined image data is selected in the second print mode, a printed product of the predetermined image data is output, and
the printed product includes a protective layer having the decorative data set in the third print mode printed thereon.

19. The printing apparatus according to claim 1, wherein the printing apparatus transitions to the third print mode in response to simultaneous pressing, by the user, of a predetermined first button and a predetermined second button during the second print mode.

20. A control method for a printing apparatus configured to access a recording medium, the control method comprising:
a first print mode of printing image data selected by a user from among a plurality of image data items stored in the recording medium;
a second print mode of printing image data automatically selected based on a predetermined rule from among the plurality of image data items stored in the recording medium; and
a third print mode of managing the second print mode.
